(19) United States
(12) Patent Application Publication
(10) Pub. No.: US 2015/0170511 A1
(43) Pub. Date: Jun. 18, 2015

(54) METHOD FOR OPERATING A MOTOR VEHICLE AND MOTOR VEHICLE

(71) Applicant: GM GLOBAL TECHNOLOGY OPERATIONS LLC, Detroit, MI (US)

(72) Inventors: Stefan BAUER, Wiesbaden (DE); Steffen KLEIN, Nierstein (DE)

(73) Assignee: GM GLOBAL TECHNOLOGY OPERATIONS LLC, Detroit, MI (US)

(21) Appl. No.: 14/109,304

(22) Filed: Dec. 17, 2013

(30) Foreign Application Priority Data
Dec. 17, 2013 (DE) 10 2012 024 613.7

(51) Int. Cl. G08G 1/00

(52) U.S. Cl. CPC G08G 1/00

(57) ABSTRACT

A method is provided for operating a motor vehicle. The motor vehicle includes, but is not limited to a coupling device designed for connecting the motor vehicle to a trailer. The method comprises determining as to whether there is a connection between the motor vehicle and a trailer with the coupling device takes place. In addition, detecting a traffic sign arranged in a surrounding region with the first sensor takes place, in the case that it is determined that there is a connection between the motor vehicle and the trailer with the coupling device, a determining as to whether the detected traffic sign includes a specific traffic regulation for motor vehicle combinations with a trailer takes place, based on data determined by a first sensor.

### CROSS-REFERENCE TO RELATED APPLICATION

This application claims priority to German Patent Application No. 10 2012 024 613.7, filed Dec. 17, 2012, which is incorporated herein by reference in its entirety.

### TECHNICAL FIELD

The application relates to a method for operating a motor vehicle, a motor vehicle, a computer program product and a computer-readable medium.

### BACKGROUND

From DE 102 42 112 A1 a method and a device for monitoring the speed of a vehicle are known. As a result of the monitoring, a reduction and/or a limitation of the speed as a function of at least one state quantity is carried out. Here, establishing the speed limitation as a function of at least one driving state quantity is provided in a configuration before starting the journey. The driving state quantity is detected both through a type-based size representing the type of the vehicle as well as through an operationally-based size representing the current vehicle operation.

At least one object is to provide a method for operating a motor vehicle, a motor vehicle, a computer program product and a computer readable-medium, which make possible a further improved operation of the motor vehicle. In addition, other objects, desirable features and characteristics will become apparent from the subsequent summary and detailed description, and the appended claims, taken in conjunction with the accompanying drawings and this background.

### SUMMARY

A method is provided for operating a motor vehicle. The motor vehicle has a coupling device. The coupling device is designed for connecting the vehicle to at least one trailer, and comprises the following steps. A determining if there is a connection between the motor vehicle and at least one trailer with the coupling device takes place. In addition, a detecting of at least one traffic sign arranged in a surrounding region of the motor vehicle with at least one first sensor of the motor vehicle takes place. If it is determined that there is a connection between the motor vehicle and at least one trailer with the coupling device, a determining as to whether the at least one detected traffic sign includes at least one specific traffic regulation for motor vehicle combinations with at least one trailer, based on data determined by the at least one first sensor, takes place. In the case that it is determined that the at least one detected traffic sign includes at least one specific traffic regulation for motor vehicle combinations with at least one trailer, a transmitting of information including the at least one determined specific traffic regulation to at least one interface of the motor vehicle takes place.

Here and in the following, a specific traffic regulation for motor vehicle combinations with at least one trailer means a traffic regulation or traffic rule which applies specifically to motor vehicle combinations with at least one trailer, however not to motor vehicles without trailer. Such traffic regulations are thus exclusively valid for motor vehicle combinations with at least one trailer.

The method according to the mentioned embodiment makes possible a further improved operation of the motor vehicle. This is effected in particular through the determining as to whether there is a connection between the motor vehicle and the at least one trailer, the determining as to whether a detected traffic sign includes at least one specific traffic regulation for motor vehicle combinations and the transmitting of information including at least one determined specific traffic regulation to at least one interface of the motor vehicle in the case that it is determined that the at least one detected traffic sign includes at least one specific traffic regulation for motor vehicle combinations with at least one trailer and it is additionally determined that there is a connection between the motor vehicle and at least one trailer by means of the coupling device.

This is based on the consideration that other regulations can apply to motor vehicle combinations, i.e., to vehicles with trailer, compared to vehicles without trailer, for example other speed limits and/or bans on overtaking. Such regulations are included in traffic signs for example in the form of an additional signboard to a regulation sign. By means of the mentioned embodiment, detection is advantageously made possible as to whether the motor vehicle is connected to a trailer or not. A traffic sign detection system of the vehicle is thus changed into a special trailer operating mode upon detection of a connection between the motor vehicle and at least one trailer and subsequently operated in this operating mode.

Because of this, dependent on the presence of a trailer, information regarding a determined specific traffic regulation for motor vehicle combinations can be provided for the operation of the motor vehicle through validating the plausibility of recognized traffic signs. By contrast, transmitting of information including at least one determined specific traffic regulation to the at least one interface of the motor vehicle is omitted in the case that it is determined that the at least one detected traffic sign includes at least one specific traffic regulation for motor vehicle combinations with at least one trailer and it is additionally determined that there is no connection between the motor vehicle and at least one trailer with the coupling device. This advantageously increases the user comfort and the acceptance of such a traffic sign recognition system.

In an embodiment of the method it is additionally determined if the at least one detected traffic sign includes a value of a speed limit. The validity of such speed limits can, as already explained, depend in particular on whether the motor vehicle has a trailer or whether it is a motor vehicle without trailer.

In the case that it is determined that the at least one detected traffic sign includes at least one specific traffic regulation for motor vehicle combinations with at least one trailer and additionally a value of a speed limit, outputting of at least the determined value of the speed limit preferably takes place in the process by means of a visual and/or acoustic message. Because of this, the occupants of the motor vehicle, in particular the driver of the motor vehicle can be alerted to a currently valid speed limit, which specifically applies to motor vehicle combinations, if there is a connection between the motor vehicle and at least one trailer by means of the coupling device.

In addition, in the case that it is determined that the at least one detected traffic sign includes at least one specific traffic regulation for motor vehicle combinations with at least on trailer and a value of a speed limit, transmitting of at least the determined value of the speed limit to at least one driver assistance system of the motor vehicle can take place. Operation of the at least one driver assistance system in this case is preferably adapted as a function of the determined value of the speed limit. For example, the determined value of the speed limit can be transmitted to a driver assistance system which supports the driver in adhering to the current speed limit. The mentioned driver assistance system, which is also called ISA (ISA, intelligent speed adaptation), can subsequently be operated based on the transmitted value of the determined speed limit.

In a further embodiment of the method, a current speed of the motor vehicle is additionally determined. In the mentioned embodiment, an automatic automation of at least one element of the motor vehicle, selected from the group consisting of a braking device, a driving device and a warning device takes place in the case that the determined current speed of the motor vehicle exceeds the determined value of the speed limit for a predetermined duration at least by a predetermined speed value. For example, a warning message can be output by means of the ISA driver assistance system in the case of the current speed limit being exceeded and/or an automatic intervention in the driving dynamics of the motor vehicle take place.

The at least one first sensor preferably comprises a first optical camera. Such optical cameras are increasingly provided for motor vehicles, by way of which the number of components needed for carrying out the method can be advantageously reduced. In addition, traffic signs and in particular the information contained in or on the traffic signs can be determined in a simple and reliable manner with an image evaluation of images recorded by the at least one first optical camera.

In particular, a determining as to whether the at least one detected traffic sign includes at least one specific traffic regulation for motor vehicle combinations with at least one trailer can include evaluating images recorded by the at least one first optical camera by means of a sample detection method. In the case that it is determined that the at least one detected traffic sign includes at least one specific traffic regulation for motor vehicle combinations with at least one trailer it can be additionally determined to which type of traction vehicle of the motor vehicle combination the traffic regulation applies.

Transmitting the information including the at least one determined specific traffic regulation to the at least one interface of the vehicle takes place in this embodiment in the case that the motor vehicle corresponds to the determined type of the traction vehicle. It can be determined furthermore to which type of trailer of the motor vehicle combination the traffic regulation applies. Transmitting the information including the at least one determined specific traffic regulation to the at least one interface of the motor vehicle in this embodiment takes place in the case that the at least one trailer corresponds to the determined type of the trailer. This is based on the consideration that other regulations can apply to vehicles with trailer depending on the type of the traction vehicle and/or of the trailer.

Determining as to whether there is a connection between the motor vehicle and at least one trailer change the coupling device can take place based on data determined by at least one second sensor of the motor vehicle. The at least one second sensor in this case is selected from the group consisting of an electromagnetic sensor, in particular a radar sensor or a lidar sensor, an acoustic sensor, in particular an ultrasound sensor, and a second optical camera, for example in the form of a reversing camera of the motor vehicle. The mentioned sensors, which are also called surround sensors are increasingly provided in motor vehicles, as a result of which the number of components needed for the method can be advantageously reduced.

In addition, a determining as to whether there is a connection between the motor vehicle and at least one trailer with the coupling device can include determining if there is an electrical coupling between the motor vehicle and at least one trailer. In particular, in the case that the coupling device is designed as a trailer coupling, a connection between the motor vehicle and a trailer can thereby be determined in a simple and reliable manner through electronic monitoring for example by means of a TIM-system (TIM, trailer interface module). Furthermore, a determining as to whether there is a connection between the motor vehicle and at least one trailer with the coupling device can include determining as to whether a confirmation of such a trailer operation has taken place by means of a user input.

The application additionally relates to a motor vehicle, which comprises a first determining device, which is designed for determining as to whether there is a connection between the motor vehicle and at least one trailer by means of a coupling device of the motor vehicle. Furthermore, the motor vehicle comprises at least one first sensor. The at least one first sensor is designed for detecting objects in a surrounding region of the motor vehicle. In addition to this, the motor vehicle comprises a second determining device, which is designed for determining as to whether a traffic sign detected by the at least one first sensor includes at least one specific traffic regulation for motor vehicle combinations with at least one trailer, in the case that it is determined that there is a connection between the motor vehicle and at least one trailer with the coupling device. Furthermore, the motor vehicle comprises a transmission device, which is designed for transmitting information including the at least one determined specific traffic regulation to at least one interface of the motor vehicle in the case that it is determined that the at least one detected traffic sign includes at least one specific traffic regulation for motor vehicle combinations with at least one trailer.

The motor vehicle has the advantages already mentioned in connection with the method according to the application, which is not mentioned again at this point to avoid repetitions. The second determining device is additionally preferably designed for determining if the at least one detected traffic sign includes a value of a speed limit. The transmission device in a further embodiment is additionally designed for transmitting at least one the determined value of the speed limit to an output device and/or to at least one driver assistance system of the motor vehicle in the case that it is determined that the at least one detected traffic sign includes at least one specific traffic regulation for motor vehicle combinations with at least one trailer and a value of a speed limit.

The output device in this case preferably comprises a visual and/or acoustic output device and can in particular be arranged in the region of an instrument cluster and/or an information and entertainment system of the motor vehicle. In a further configuration, the output device is designed as a visual output device designed as head-up display. The coupling device of the motor vehicle can in particular be designed as a detachable coupling device, for example as a detachable trailer coupling. The motor vehicle is for example a passenger car or a utility vehicle.

A computer program product is also provided that is executed on a computer unit of a motor vehicle. The motor vehicle comprises a coupling device that is designed for connecting the motor vehicle to at least one trailer, instructs the computer unit to carry out the following steps. The computer unit is instructed to determine if there is a connection between the motor vehicle and at least one trailer with the coupling device. In addition, the computer unit is instructed for detecting at least one traffic sign arranged in a surrounding region of the motor vehicle with at least one first sensor of the motor vehicle. In the case that it is determined that there is a connection between the motor vehicle and at least one trailer with the coupling device, the computer units is instructed to determine if the at least one detected traffic sign includes at least one specific traffic regulation for motor vehicle combinations with at least one trailer, based on data determined by the at least one first sensor. In the case that it is determined that the at least one detected traffic sign includes at least one specific traffic regulation for motor vehicle combinations with at least one trailer, the computer unit is instructed furthermore to transmit information including the at least one determined specific traffic regulation to at least one interface of the motor vehicle.

A computer-readable medium is also provided on which a computer program product according to the mentioned embodiment is stored. The computer program product and the computer-readable medium have the advantages already mentioned in connection with the method according to the application, which at this point is not mentioned again in order to avoid repetitions.

The motor vehicle, the computer program product and the computer-readable medium are suitable in particular for carrying out the method, where this can also apply to the configurations and further developments of the method. To this end, the motor vehicle in particular can comprise further suitable devices or components.

### BRIEF DESCRIPTION OF THE DRAWINGS

The present invention will hereinafter be described in conjunction with the following drawing figures, wherein like numerals denote like elements, and:

FIG. 1 shows a flow diagram of a method for operating a motor vehicle according to an embodiment;

FIG. 2 shows an example of a driving situation in which the method according can be employed; and

FIG. 3 shows components of the motor vehicle shown in FIG. 2 according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

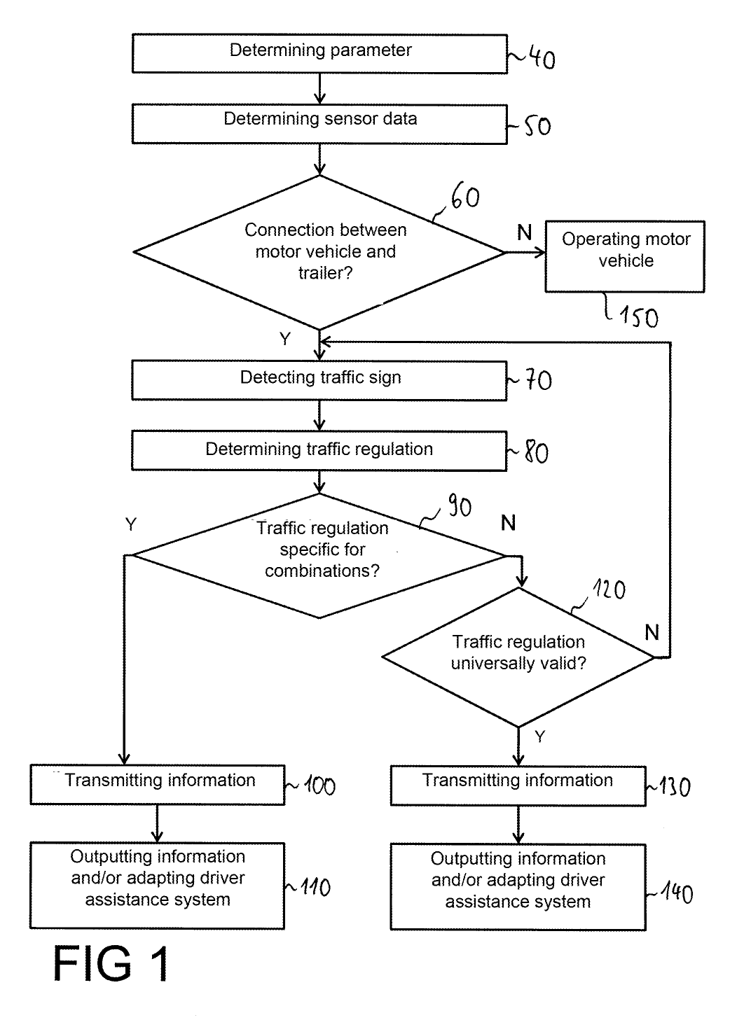

FIG. 1 shows a flow diagram of a method for operating a motor vehicle according to an embodiment. The motor vehicle comprises a coupling device. The coupling device is designed for connecting the motor vehicle to at least one trailer. The motor vehicle is for example a passenger car and the coupling device in this case designed as a trailer coupling with which a trailer can be connected to the motor vehicle.

In a step 40, a determining of at least one parameter characterizing an imminent driving operation of the motor vehicle takes place. For example, switching-on of an ignition system of the motor vehicle or opening of a door lock of the motor vehicle can be determined. It can be determined, furthermore, if for example the driver's door of the motor vehicle is being opened.

In a step 50, a determining of data with at least one second sensor of the motor vehicle takes place. Based on the determined data a possible connection between the motor vehicle and at least one trailer can be determined. For example, a determining of data with an electromagnetic sensor arranged in a rearward region of the motor vehicle, in particular of a radar sensor or of a lidar sensor, of an acoustic sensor, in particular of an ultrasound sensor, and/or with an optical camera in the form of a reversing camera takes place.

Furthermore, sensor data can be determined with an electrical coupling between the motor vehicle and at least one trailer can be determined. For example, such data can be determined by means of a cable or plug connection through a TIM-system, in particular in the case that the coupling device is designed as a trailer coupling of the motor vehicle.

In a step 60, it is determined based on the data determined in the step 50, if there is a connection between the motor vehicle and at least one trailer with the coupling device. If in the process it is determined that there is a connection between the motor vehicle and at least one trailer with the coupling device, a traffic sign detection system of the motor vehicle is operated in a special trailer operating mode, as is explained in more detail in the following.

In addition, in the case that it is determined in the step 60 that there is a connection between the motor vehicle and at least one trailer with the coupling device, adapting an emergency braking system of the motor vehicle can take place in such a manner that a danger emergency braking by means of the emergency braking system in the case of an existing connection between the motor vehicle and at least one trailer is omitted. This is based on the consideration that in such a driving mode with trailer an automatic danger emergency braking constitutes a higher danger potential for the motor vehicle compared with an omitted automatic danger emergency braking.

In the shown embodiment, detecting of at least one traffic sign arranged in a surrounding region of the motor vehicle takes place in a step 70 with at least one first sensor of the motor vehicle. The at least one first sensor to this end comprises for example an optical camera in the front of a front camera of the motor vehicle.

In a step 80, a determining of information included on the traffic sign takes place. For example, based on data determined by the at least one first sensor, a determining of traffic regulations included on a traffic sign takes place. The information included on the traffic sign is for example determined by means of an image evaluation of images recorded by the first optical camera. Furthermore, the information can be transmitted to the motor vehicle with a vehicle-to-infrastructure communication device from the traffic sign. In particular, it can be determined a step 80 if the at least one detected traffic sign includes a value of a speed limit.

In a step 90, it is additionally determined based on data determined by the at least one first sensor if the at least one detected traffic sign includes at least one specific traffic regulation for vehicle combinations with at least one trailer. In the shown embodiment it is determined in addition if the traffic regulation determined in the step 80 specifically applies to motor vehicle combinations, for example by evaluating the images recorded by the at least one first optical camera with a sample recognition method.

If it is determined that the at least one detected traffic sign includes at least one specific traffic regulation for motor vehicle combinations with at least one trailer, transmitting of information including the at least one determined specific traffic regulation to at least one interface of the motor vehicle takes place in a step 100. In a step 110, outputting the information including the at least one determined specific traffic regulation with a visual and/or acoustic message additionally takes place. For example, outputting of a determined value of a speed limit with a visual and/or acoustic message takes place in the step 110, in the case that it is determined in the step 80 that the at least one detected traffic sign includes a value of a speed limit and it is additionally determined in the step 90 that the speed limit specifically applies to motor vehicle combinations with at least one trailer.

Additionally or alternatively transmitting of the information including the at least one determined specific traffic regulation to at least one driver assistance system of the motor vehicle and adapting the operation of the at least one vehicle assistance system as a function of the transmitted information takes place in the step 110. For example, a value of a speed limit specifically applying to motor vehicle combinations can be transmitted to the at least one driver assistance system and the latter adapted as a function of the transmitted value of the speed limit.

If, by contrast, it is determined in the step 90 that the at least one detected traffic sign does not include any specific traffic regulation for motor vehicle combinations with at least one trailer, it is determined in a step 120 if the traffic regulation included in the traffic sign is generally valid, i.e., applies to all motor vehicles. It is determined for example if a speed limit included in the traffic sign is valid for all motor vehicles.

If it is determined in the process that the traffic regulation is not universally valid, the steps 70, 80, 90 as well as 100 and 110 and 120 if appropriate are carried out repeatedly. If by contrast it is determined that the traffic regulation is universally valid, transmitting of information including the determined universally valid traffic regulation to the at least one interface of the motor vehicle takes place in a step 130.

Furthermore, outputting of the transmitted information by means of a visual and/or acoustic message and/or adapting of the at least one driver assistance system of the motor vehicle as a function of the transmitted information takes place in a step 140. If it is determined in the step 60 that there is no connection between the motor vehicle and at least one trailer by means of the coupling device, i.e., that no trailer is connected to the motor vehicle with the coupling device, a corresponding operating mode of the motor vehicle and in particular of the traffic sign recognition system without trailer is determined as is shown with a step 150.

In this operating mode it can be determined likewise based on data determined by the at least one first sensor if a detected traffic sign includes at least one specific traffic regulation for motor vehicle combinations with at least one trailer. If this is the case, transmitting of this specific traffic regulation to the at least one interface of the motor vehicle is however omitted in the mentioned operating mode of the traffic sign recognition system. In particular, outputting a visual and/or acoustic message or adapting of the operation of the at least one driver assistance system is omitted.

If, however, it is determined in this operating mode that a detected traffic sign includes a universally valid traffic regulation, transmitting of information including the determined universally valid traffic regulation to the at least one interface of the motor vehicle again takes place. In this case, outputting of the transmitted information and/or adapting of the at least one driver assistance system of the motor vehicle additionally takes place.

By means of the shown embodiment, automatic recognition or validating the plausibility is made possible as to whether a trailer is present or not. Dependent on the presence of a trailer, an indication of the “correct” regulation sign based on the traffic sign recognition and/or a regulation of the vehicle speed or a non-regulation in the case of a danger emergency braking for example takes place.

The recognition as to whether a trailer is present or not can, as already been explained, take place in particular through electronic monitoring by means of a trailer interface module or by monitoring of the rear vehicle region, for example through ultrasound sensors, which are employed for a parking assistant of the motor vehicle. If a trailer is present, the correct speed for combinations is indicated or an adaptive speed regulation can take place in the case of combinations. Thus, a validating of the plausibility of traffic signs recognized with the traffic sign recognition and in particular an indication or regulation of speed limits for combinations based on this information takes place.

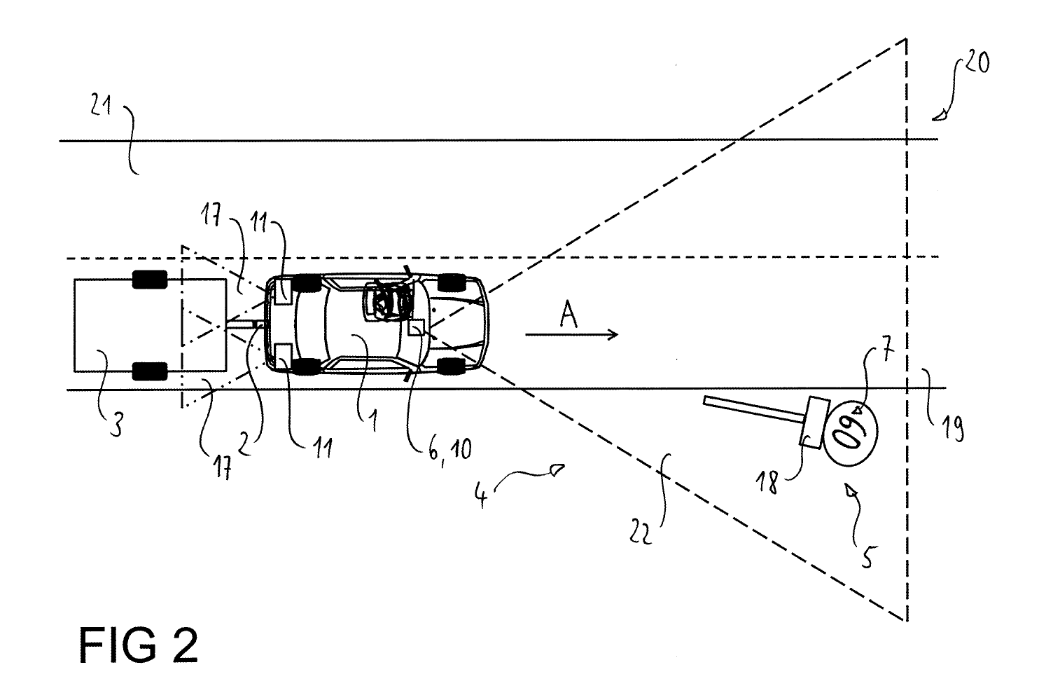

FIG. 2 shows an example of a driving situation, in which the method, in particular the method according to the embodiment shown in FIG. 1 can be employed. In the shown situation, a motor vehicle 1 in the form of a passenger car travels on a first lane 19 of a road 20 in a travelling direction schematically shown by means of an arrow A. Next to the first lane 19, the road 20 additionally comprises a further lane 21.

The motor vehicle 1 comprises at least one first sensor 6. The at least one first sensor 6 in the shown situation is designed as an optical camera 10. The first sensor 6 in the form of the optical camera 10 is formed for detecting objects within a schematically shown detection range 22 and thus for detecting objects in the range of a current surroundings 4 of the motor vehicle 1.

In the shown situation, a traffic sign 5 in the form of a traffic sign board is located within the detection range 22 of the optical camera 10. The traffic sign 5 in this case includes a traffic regulation 7 in the form of a speed limit applicable to the lane 19. The speed limit in this case is restricted to motor vehicle combinations with at least one trailer by means of information included on an additional board 18 of the traffic sign 5 which is not shown in more detail in FIG. 2, i.e., the traffic sign 5 includes a specific traffic regulation 7 for motor vehicle combinations with at least one trailer.

In the shown situation there is a connection between the motor vehicle 1 and a trailer 3 with a coupling device 2 of the motor vehicle 1, wherein the coupling device 2 is designed as a trailer coupling.

The motor vehicle 1 in the shown embodiment additionally comprises two second sensors 11, which are designed for example as radar sensors, as lidar sensors or as ultrasound sensors. The second sensors 11 are arranged in a rearward region of the motor vehicle 1 and comprise a schematically shown detection range 17 each. The trailer 3 is at least partially located within the detection range 17 of the two second sensors 11, by way of which based on data determined by the second sensors 11 a connection between the motor vehicle 1 and the trailer 3 can be determined.

As is explained in more detail in connection with the following figure, outputting of a value of the speed limit of the traffic sign 5 determined based on images recorded by the optical camera 10 and/or transmitting of the determined value of the speed limit to at least one driver assistance system of the motor vehicle 1 takes place in the shown driving situation.

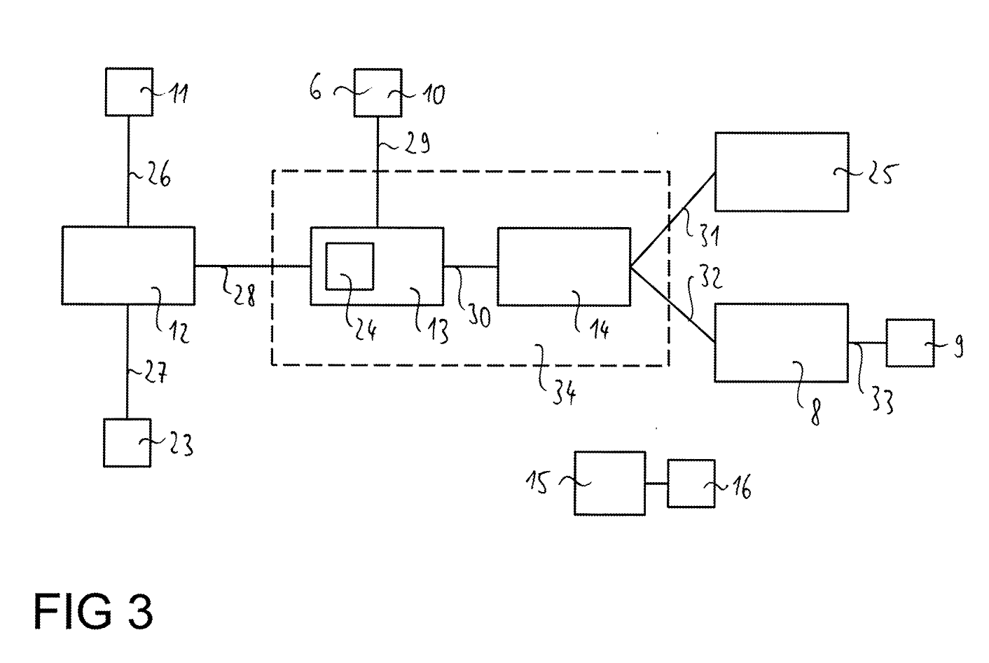

To this end, FIG. 3 shows components of the motor vehicle 1 shown in FIG. 2 according to an embodiment of the application. Components with the same functions as in FIG. 2 are marked with the same reference characters and are not explained again in the following. For the sake of clarity, the vehicle and the trailer are not shown in any detail in FIG. 3.

The motor vehicle comprises a first determining device 12, which is designed for determining as to whether there is a connection between the motor vehicle and at least one trailer with the coupling device of the motor vehicle which is not shown in any detail in FIG. 3. To this end, the first determining device 12 in the shown embodiment is connected to the second sensors 11 via a signal line 26, wherein in FIG. 3 for the sake of clarity merely one of the two second sensors 11 is shown. Furthermore, the first determining device 12 is connected via a signal line 27 to a sensor 23, which is designed for determining if there is an electrical coupling between the motor vehicle and at least one trailer.

In addition, the motor vehicle comprises a second determining device 13, which is designed for determining if a traffic sign detected by the at least one first sensor 6 in the form of the optical camera 10 includes at least one specific traffic regulation for motor vehicle combinations with at least one trailer. In addition, the second determining device 13 in the shown embodiment is designed for determining if the at least one detected traffic sign includes a value of a speed limit. The second determining device 13 to this end is connected to the first sensor 6 via a signal line 29. In addition to this, the second determining device 13 is connected via a signal line 28 to the first determining device 12. The second determining device 13 additionally comprises a storage unit 24 with samples for traffic regulations stored thereon. The second determining device 13 is thus designed for determining if the detected traffic sign includes a specific traffic regulation for motor vehicle combinations by evaluating images recorded by the optical camera 10 with a sample recognition method.

In addition, the motor vehicle comprises a transmission device 14, which is designed for transmitting information including at least one determined specific traffic regulation to at least one interface of the motor vehicle in the case that it is determined that the at least one detected traffic sign includes at least one specific traffic regulation for motor vehicles with at least one trailer and it is additionally determined that there is a connection between the motor vehicle and at least one trailer. Furthermore, the transmission device 14 in the shown embodiment is designed for transmitting information including a universally valid traffic regulation to the at least one interface of the motor vehicle in the case that the detected traffic sign includes such a universally valid traffic regulation. The transmission device 14 to this end is connected via a signal line 30 to the second determining device 13 and via a signal line 31 to an output device 25 and via a signal line 32 to a driver assistance system 8 of the motor vehicle. Transmitting a determined specific traffic regulation for motor vehicle combinations with at least one trailer by contrast is omitted in the case that there is no connection between the motor vehicle and at least one trailer.

In the shown embodiment, the second determining device 13 and the transmission device 14 are part of a traffic sign recognition system 34 of the motor vehicle. The output device 25 is designed for outputting the information including the determined respective traffic regulation. To this end, the output device 25 is designed for example as visual and/or acoustic output device. In particular, as already explained above, a determined value of a speed limit can be output by means of the output device 25 as a function of the respective operating situation of the motor vehicle.

In the shown embodiment, the driver assistance system 8 is designed for automatically actuating at least one element 9 of the motor vehicle, selected from the group consisting of a braking device and a driving device. To this end, the driver assistance system 8 is connected via a signal line 33 to the at least one element 9. Operation of the driver assistance system 8, as likewise already explained, can be adapted as a function of the transmitted information including the determined traffic regulation dependent on whether the motor vehicle is connected to a trailer or not.

Furthermore, the motor vehicle in the shown embodiment comprises a computer unit 15 and a computer-readable medium 16. On the computer-readable medium 16 a computer program product is stored which, when it is executed on the computer unit 15, instructs the computer unit to carry out the steps mentioned in connection with the embodiments of the method, in particular the steps of the embodiment shown in FIG. 1, with the elements thereby mentioned. To this end, the computer unit 15 is directly or indirectly connected to the relevant elements in a manner which is not shown in any detail.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for operating a motor vehicle that comprises a coupling device that is configured to connect the motor vehicle to a trailer, the method comprising:
determining whether there is a connection between the motor vehicle and a trailer with the coupling device;
detecting a traffic sign arranged in a surrounding region of the motor vehicle with a first sensor of the motor vehicle;
determining whether the detected traffic sign includes a specific traffic regulation for motor vehicle combinations with a trailer based on data determined by the first sensor if there is a connection between the motor vehicle and the trailer with the coupling device; and
transmitting information including the determined specific traffic regulation to an interface of the motor vehicle if the at least one detected traffic sign includes a specific traffic regulation for motor vehicle combinations with a trailer.

2. The method according to claim 1, further comprising additionally determining if the detected traffic sign includes a value of a speed limit.

3. The method according to claim 2, further comprising outputting the determined value of the speed limit with a message if the detected traffic sign includes a specific traffic regulation for motor vehicle combinations with a trailer and a value of a speed limit.

4. The method according to claim 3, further comprising transmitting the determined value of the speed limit to the driver assistance system of the motor vehicle if the detected traffic sign includes the specific traffic regulation for motor vehicle combinations with the trailer and the value of a speed limit.

5. The method according to claim 4, wherein an operation of the driver assistance system is a function of the transmitted value of the speed limit.

6. The method according to claim 3, further comprising:
additionally determining a current speed of the motor vehicle; and
automatically actuating of the motor vehicle.

7. The method according to claim 1, wherein the first sensor comprises a first optical camera.

8. The method according to claim 7, wherein determining whether the detected traffic sign comprises evaluating images recorded by the first optical camera with a sample recognition method.

9. The method according to claim 1,
wherein determining if there is a connection between the motor vehicle and the trailer with the coupling device takes place based on data determined by a second sensor of the motor vehicle, and
wherein the second sensor is an electromagnetic sensor.

10. The method according to claim 1, wherein determining if there is a connection between the motor vehicle and the trailer with the coupling device comprises determining if there is an electrical coupling between the motor vehicle and the trailer.

11. A motor vehicle, comprising:
a first determining device that is configured to determine if there is a connection between the motor vehicle and a trailer with a coupling device of the motor vehicle;
a first sensor that is configured to detect objects in a surrounding region of the motor vehicle;
a second determining device that is configured to determine if a traffic sign detected by the first sensor comprises a specific traffic regulation for motor vehicle combinations with the trailer, in the event that it is determined that there is a connection between the motor vehicle and at least one trailer with the coupling device; and
a transmission device that is configured to transmit information comprising the determined specific traffic regulation to an interface of the motor vehicle, in the case that it is determined that the detected traffic sign includes the specific traffic regulation for motor vehicle combinations with the trailer.

12. The motor vehicle according to claim 11, wherein the second determining device is additionally configured to determine if the detected traffic sign includes a value of a speed limit.

13. The motor vehicle according to claim 12, wherein the transmission device is additionally configured to transmit the determined value of the speed limit to an output device in the case that it is determined that the detected traffic sign includes the specific traffic regulation for motor vehicle combinations with the trailer and a value of a speed limit.

14. A non-transitory computer readable medium embodying a computer program product, said computer program product comprising:
a program, the program configured to:
determine whether there is a connection between a motor vehicle and a trailer with the coupling device;
detect a traffic sign arranged in a surrounding region of the motor vehicle with a first sensor of the motor vehicle;
determine whether the detected traffic sign includes a specific traffic regulation for motor vehicle combinations with the trailer based on data determined by the first sensor if there is a connection between the motor vehicle and a trailer with the coupling device; and
transmit information including the determined specific traffic regulation to an interface of the motor vehicle if the detected traffic sign includes at least one specific traffic regulation for motor vehicle combinations with the trailer.

15. (canceled)
